(19) United States
(12) Patent Application Publication
(10) Pub. No.: US 2008/0311866 A1
(43) Pub. Date: Dec. 18, 2008

(54) Reconfiguration in Radio Communication Systems

(75) Inventors: Pierre Roux, Val D'oise (FR); Soodesh Buljore, Ile De France (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/160,384

(22) PCT Filed: Jan. 18, 2007
(86) PCT No.: PCT/US07/60666

§ 371 Date: Jul. 9, 2008

(30) Foreign Application Priority Data
Jan. 20, 2006 (GB) 0601237.1

(51) Int. Cl. H04B 1/04

(52) U.S. Cl. 455/127.1

(57) ABSTRACT

A radio communication system (100) transmits performance requirement notifications defining performance requirements for the operation of a radio equipment (101). The performance requirements are received from a regulation body responsible for certifying the operation of the communication system (100). The reconfigurable radio equipment (101) comprises a reconfigurable radio element (303) and a secure certification processor (301). The secure certification processor (301) comprises a monitoring processor (325) which monitors compliance of the reconfigurable radio element (303) with a set of performance requirements. A validation processor (321) verifies the performance requirement notification and a requirements processor (323) updates the performance requirements in response to the notifications if these are valid. The monitoring processor (325) enters the reconfigurable radio equipment (101) into a limited mode of operation if the reconfigurable radio element (303) is not compliant with the performance requirements.

### FIELD OF THE INVENTION

The invention relates to reconfiguration in radio communication systems and in particular, but not exclusively, to reconfiguration of software reconfigurable radio devices.

### BACKGROUND OF THE INVENTION

Radio communication systems and in particular radio networks have become widespread in the last decades and are now e.g. used for mobile communications and wireless data networks.

In order to ensure reliable coexistence and interactions between equipment typically originating from many different manufacturers and providers, most radio communication systems are based on well defined technical specifications developed by a suitable standards body. For example, the currently most widespread cellular communication system GSM (Global System for Mobile communications) is based on the GSM Recommendations developed by the European Telecommunication Standards Institute, 3^{rd} generation cellular communication systems, including the Universal Mobile Telecommunication System (UMTS), are based on the Technical Specifications developed by the 3^{rd} Generation Partnership Project (3GPP) and the popular wireless local area networks IEEE802.11x are based on specifications developed by the Internet Engineering Task Force (IETF).

In order to ensure appropriate operation of the communication systems, it is necessary to ensure that all deployed equipment meet the technical specifications. For this purpose, most communication systems have an associated regulation or certification body that verifies that the equipment is compliant with the specifications.

Furthermore, the deployment of several radio networks in the same area usually requires a regulation body to issue rules for ensuring coexistence between the different radio networks. Typically, non-overlapping frequency bands are assigned to different operators and transmission requirements are defined to ensure that interference between different systems is reduced to acceptable levels.

Thus, for most non-proprietary radio communication systems, a manufacturer must obtain certification of a device from one or several regulation bodies before putting this on the market. The regulation body will perform tests on one (or a few) device(s) in order to make sure that the model complies with the technical specifications for the communication system.

However, although this allows management of the reliability of the communication system(s), it also has a number of associated disadvantages. Specifically, it tends to lead to complex and time consuming certification/authorization processes. Furthermore, as the tests are performed on a few sample devices, a risk remains that individual units may not meet the requirements, for example due to a fault or due to variations between different units or to variations between the test environment and the operational environment.

For example, radio equipment, such as mobile radio devices, is becoming increasingly versatile and flexible and it is expected that this trend will continue. Specifically, radio equipment is increasingly becoming reconfigurable and updatable allowing existing equipment to be improved or reconfigured for different environments. For example, a device may be reconfigured to exploit different frequency bands, different modulation schemes or different radio waveforms. Patches can be applied to devices resulting in modified radio characteristics. A more extreme example is Software Definable Radios (SDRs) which are developed and designed specifically with easy reconfigurability in mind.

In many such cases, an exhaustive check of the operation for all possible configurations in advance is not possible or practical. Accordingly, the conventional approach of using a certification of sample devices by a regulation body is impossible or at least impractical.

For SDRs it has been proposed to introduce a scheme where combinations of hardware platforms and software versions can be individually certified/authorized by a regulation authority. Specifically, the proposal includes the introduction of a certification matrix which has different hardware platforms in one direction (e.g. a column for each hardware platform) and software versions in the other direction (e.g. a row for each software version). Each cell of the certification matrix can then be filled out by the regulation body to specify whether the specific corresponding hardware/software combination has been tested and authorized. If so, a digital certificate is provided to the manufacturer specifying which hardware/software combinations can be used. However, this certification framework is complex and time consuming and requires testing of all individual software and hardware combinations before these can be used. Furthermore, it only provides testing of selected samples in test environments and thus do not ensure that the requirements are met by all devices during actual operation.

Hence, an improved reconfiguration would be advantageous and in particular reconfiguration allowing for increased flexibility, reduced complexity, increased reliability and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a reconfigurable radio equipment for a radio communication system, the reconfigurable radio equipment comprising: a reconfigurable radio element; receiving means for receiving performance requirement notifications over an air interface of the radio communication system, the performance requirement notifications defining performance requirements for the operation of the reconfigurable radio equipment; a secure certification processor comprising: monitoring means for monitoring compliance of the reconfigurable radio element with a first set of performance requirements; validation means for verifying the validity of a received performance requirement notification; update means for updating the first set of performance requirements in response to the received performance requirement notification only if the received performance requirement notification is valid; and wherein the monitoring means is arranged to enter the reconfigurable radio equipment into a limited mode of operation if the reconfigurable radio element is not compliant with the first set of performance requirements.

The invention may allow improved reconfiguration of a reconfigurable radio equipment in a radio communication system. A much facilitated reconfiguration can be achieved while allowing regulation authorities to ensure that performance requirements are met. A flexible reconfiguration may be allowed without requiring that all individual configurations are specifically tested and authorised in advance. The invention may allow improved reliability of the reconfigurable radio equipment and may reduce the probability that an operational reconfigurable radio equipment does not meet the prescribed performance requirements.

The invention may allow improved verification of the operation of a reconfigurable radio equipment while reducing the requirement for and/or complexity of authentication of reconfigurations by a regulation body. The invention may e.g. provide a reconfigurable radio equipment with two domains wherein a first domain is freely reconfigurable whereas a second domain is secure and is arranged to monitor the operation of the first domain to ensure that this meets the performance requirements. Hence, certification of performance may be restricted to a monitoring function which typically is only rarely (or never) reconfigured while providing a system where a central regulation body can control and ensure acceptable operation of the individual reconfigurable equipment.

The performance requirement notifications may for example comprise performance requirements defined by a regulation body which may be external to the radio communication system.

The reconfigurable radio equipment may for example be a Software Definable Radio. The operation of the secure certification processor is secure such that the operation cannot be modified in the absence of authentication of an authentication/certification/regulation body responsible for the operation of the radio communication system.

The radio communication system may be a hybrid radio communication system including different radio communication networks such as for example both a cellular and a WLAN communication system. The reconfigurable radio element can be any functionality which affects a transmitted radio signal and/or is used in receiving a radio signal. For example, the reconfigurable radio element can be a transceiver, a transmitter, a receiver, a transmit controller or a receive controller. The first set of performance requirements may comprise one or more performance requirements.

According to an optional feature of the invention, the first set of performance requirements comprises a transmit power requirement.

This may provide particularly advantageous performance and may in particular provide for flexible and facilitated reconfiguration while providing a low risk of unacceptable impact to the system and in particular may provide for interference from the reconfigurable radio equipment to be maintained sufficiently low.

According to an optional feature of the invention, the first set of performance requirements comprises a transmit power spectral mask.

This may provide particularly advantageous performance and may in particular provide for flexible and facilitated reconfiguration while providing a low risk of unacceptable impact to the system and in particular may provide for interference from the reconfigurable radio equipment to be maintained sufficiently low.

According to an optional feature of the invention, the limited mode of operation comprises a reduction of output transmit power.

The reduction in the limited mode of operation may be a full reduction corresponding to transmissions being switched off. This may provide an efficient way of allowing flexible reconfiguration while reducing the risk of detrimental impacts on the radio communication system. In particular, it may allow flexible reconfiguration while ensuring that interference of any configuration is below the required level.

According to an optional feature of the invention, the received performance requirement notification comprises a digital signature of a source of the performance requirements; and wherein the validation means is arranged to validate the received performance requirement notification by validating the digital signature.

The source may for example be an external or internal authentication/certification/regulation body. The digital signature may be compared to a certificate for the source. The first set of performance requirements will only be updated if the digital signature is that of an appropriate source. The feature may allow an efficient and secure operation while allowing flexible and facilitated reconfiguration.

According to an optional feature of the invention, the receiving means is arranged to receive the performance requirement notifications in broadcast messages.

This may provide improved operation in a radio communication system and may in particular provide efficient centralised management of performance requirements for a plurality of reconfigurable radio equipment.

According to an optional feature of the invention, the secure certification processor is not reconfigurable.

This may allow high security and may provide an efficient and low complexity way of ensuring acceptable performance of reconfigurable radio equipment while allowing flexible and facilitated reconfigurability.

According to an optional feature of the invention, the secure certification processor further comprises: means for receiving reconfiguration parameters for the secure certification processor; means for verifying the validity of received reconfiguration parameters; and means for reconfiguring the secure certification processor only if the received reconfiguration parameters are valid.

This may allow a high security and may provide an efficient and low complexity way of ensuring acceptable performance of reconfigurable radio equipment while allowing flexible and facilitated reconfigurability.

Furthermore, the feature may allow a flexible centralised management of the performance requirements and thus of the operation of the reconfigurable radio equipments in the system. The validity of the received reconfiguration parameters may e.g. be determined by validating a source of the reconfiguration parameters, for example by verifying a digital signature.

The reconfiguration parameters may e.g. be replacement firmware or software.

According to an optional feature of the invention, the reconfigurable radio equipment further comprises means for receiving reconfiguration parameters for the reconfigurable radio element over the air interface and means for reconfiguring the radio element in response to the reconfiguration parameters.

The invention may allow improved and/or facilitated reconfiguration. The reconfiguration parameters may for example be operational parameters or may e.g. be executable code to be implemented by the reconfigurable radio element. Specifically, the reconfiguration parameters may be replacement software or firmware for some or all software of the reconfigurable radio element.

According to an optional feature of the invention, the validation means is arranged to verify the validity of the received performance requirement notification by verifying that the received performance requirement notification is certified by a certification authority; and wherein the reconfigurable radio element is arranged to be reconfigured without verifying that the reconfiguration is certified by the certification authority.

The invention may allow improved and/or facilitated reconfiguration. For example, a certification authority of a regulation body is only required to be involved with reconfiguration for a domain which is rarely (or never) reconfigured and/or which only has few operational configurations. The certified domain can be arranged to monitor the operation of a second domain that can be reconfigured without involving the certification authority. The second domain can be frequently reconfigured or may have a large number of possible configurations.

The reconfiguration parameters may for example be operational parameters or may e.g. be executable code to be implemented by the reconfigurable radio element.

Specifically, the reconfiguration parameters may be replacement firmware or software for some or all firmware or software of the reconfigurable radio element.

According to an optional feature of the invention, the air interface is an air interface of a cellular communication system.

The invention may allow improved reconfiguration in a cellular communication system.

According to an optional feature of the invention, the reconfigurable radio equipment is a remote terminal of a cellular communication system.

The invention may allow improved and/or facilitated reconfiguration of a remote terminal, such as a user equipment or mobile station, in a cellular communication system.

According to another aspect of the invention, there is provided a radio communication system comprising: means for receiving performance requirement reconfiguration parameter messages from a certification server; means for generating performance requirement notifications in response to the performance requirement reconfiguration parameter messages, the performance requirement notifications defining performance requirements for the operation of at least one reconfigurable radio equipment; and means for transmitting the performance requirement notifications to remote units over an air interface of the radio communication system.

The invention may allow improved reconfiguration of a reconfigurable radio equipment in a radio communication system. A much facilitated reconfiguration can be achieved while allowing regulation authorities to ensure that performance requirements are met. A flexible reconfiguration may be allowed without requiring that all individual configurations are specifically tested and authorised in advance. The invention may allow improved reliability of the reconfigurable radio equipment and may reduce the probability that an operational reconfigurable radio equipment does not meet the prescribed performance requirements.

The invention may allow improved verification of the operation of a reconfigurable radio equipment while reducing the requirement for and/or complexity of authentication/certification of reconfigurations by a regulation body.

The performance requirement notifications may for example comprise performance requirements defined by a regulation body which may be external to the radio communication system.

The reconfigurable radio equipment may for example be a Software Definable Radio. The radio communication system may be a hybrid radio communication system including different radio communication networks such as for example both a cellular and a WLAN communication system.

According to an optional feature of the invention, at least one of the remote units is a reconfigurable radio equipment comprising: a reconfigurable radio element; receiving means for receiving the performance requirement notifications; a secure certification processor comprising: monitoring means for monitoring compliance of the reconfigurable radio element with a first set of performance requirements; validation means for verifying the validity of a received performance requirement notification; update means for updating the first set of performance requirements in response to the received performance requirement notification only if the received performance requirement notification is valid; and wherein the monitoring means is arranged to enter the reconfigurable radio equipment into a limited mode of operation if the reconfigurable radio element is not compliant with the first set of performance requirements.

The invention may allow improved and/or facilitated reconfiguration of a reconfigurable radio equipment.

According to an optional feature of the invention, the performance requirement reconfiguration parameter messages comprise a digital signature of a regulating authority and wherein the means for generating performance requirement notifications comprise means for validating the digital signature.

This may allow an improved and/or facilitated reconfiguration framework and may in particular allow improved reliability. If the digital signature is not valid, the performance requirement notifications are not transmitted to the reconfigurable radio equipments.

According to an optional feature of the invention, the performance requirement reconfiguration parameter messages comprise a digital signature of a regulating authority, the means for generating performance requirement notifications comprise means for including the digital signature in the performance requirement notifications and the remote units comprise means for validating the digital signature.

This may allow an improved and/or facilitated reconfiguration framework and may in particular allow improved reliability. In particular, it may allow the reconfigurable radio equipment itself to verify that the performance requirements originate from the appropriate authentication/certification/regulation authority. The validity means may e.g. be arranged to check the digital signature against a digital signature for a predetermined regulation body and only if this matches is the first set of performance requirements updated in response to the performance requirement notifications.

According to an optional feature of the invention, the means for generating performance requirement notifications comprise means for including a network digital signature of an operator of the radio communication system in the performance requirement notifications and the remote units comprise means for validating the network digital signature.

This may allow an improved and/or facilitated reconfiguration framework and may in particular allow improved reliability. In particular, it may allow the reconfigurable radio equipment itself to verify that the radio network operator has authenticated the performance requirements. The validity means may e.g. be arranged to check the digital signature against a digital signature for a predetermined network operator and only if this matches is the first set of performance requirements updated in response to the performance requirement notifications.

According to an optional feature of the invention, the means for generating performance requirement notifications comprise means for including an identification of an applicability of the performance requirements.

This may allow a more flexible reconfiguration. The identification of the applicability may for example specify a manufacturer, a device model, a firmware version, a geographical area or a time interval for which the modified performance requirements are valid.

According to another aspect of the invention, there is provided a method of reconfiguring a reconfigurable radio equipment having a reconfigurable radio element, the method comprising: receiving performance requirement notifications over an air interface of the radio communication system, the performance requirement notifications defining performance requirements for the operation of the reconfigurable radio equipment; and in a secure certification processor performing the steps of: monitoring compliance of the reconfigurable radio element with a first set of performance requirements; verifying the validity of a received performance requirement notification; updating the first set of performance requirements in response to the received performance requirement notification only if the received performance requirement notification is valid; and entering the reconfigurable radio equipment into a limited mode of operation if the reconfigurable radio element is not compliant with the first set of performance requirements.

According to another aspect of the invention, there is provided a method of reconfiguration in a radio communication system, the method comprising: receiving performance requirement reconfiguration parameter messages from a network regulation server; generating performance requirement notifications in response to performance requirement reconfiguration parameter messages, the performance requirement notifications defining performance requirements for the operation of at least one reconfigurable radio equipment; and transmitting the performance requirement notifications to remote units over an air interface of the radio communication system.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates a system for controlling reconfiguration in accordance with some embodiments of the invention; and

FIG. 3 illustrates an example of a reconfigurable radio equipment in accordance with some embodiments of the invention.

### DETAILED DESCRIPTION OF SOME EMBODIMENTS OF THE INVENTION

The following description focuses on embodiments of the invention applicable to a cellular communication system and in particular to a Universal Mobile Telecommunication System (UMTS) cellular communication system. However, it will be appreciated that the invention is not limited to this application but may be applied to many other communication systems including for example Wireless Local Area Networks (WLANs) or hybrid radio communication systems, such as a radio communication system comprising both a cellular communication system and a WLAN.

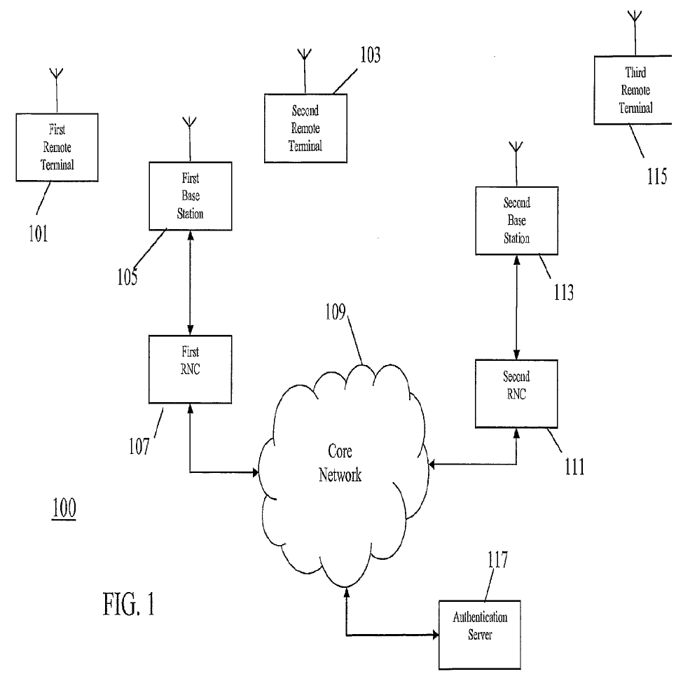

FIG. 1 illustrates an example of a cellular communication system 100 in accordance with some embodiments of the invention.

In a cellular communication system, a geographical region is divided into a number of cells each of which is served by a base station (each of which may serve a plurality of cells and/or sectors). The base stations are interconnected by a fixed network which can communicate data between the base stations. A remote terminal (e.g. a User Equipment (UE) or a mobile station) is served via a radio communication link by the base station of the cell within which the remote terminal is situated.

As a remote terminal moves, it may move from the coverage of one base station to the coverage of another, i.e. from one cell to another. As the remote terminal moves towards a base station, it enters a region of overlapping coverage of two base stations and within this overlap region it changes to be supported by the new base station. As the remote terminal moves further into the new cell, it continues to be supported by the new base station. This is known as a handover or handoff of a remote terminal between cells.

A typical cellular communication system extends coverage over typically an entire country and comprises hundreds or even thousands of cells supporting thousands or even millions of remote terminals. Communication from a remote terminal to a base station is known as uplink, and communication from a base station to a remote terminal is known as downlink.

In the example of FIG. 1, a first remote terminal 101 and a second remote terminal 103 are in a first cell supported by a first base station 105.

The first base station 105 is coupled to a first RNC 107. An RNC performs many of the control functions related to the air interface including radio resource management and routing of data to and from appropriate base stations.

The first RNC 107 is coupled to a core network 109. A core network interconnects RNCs and is operable to route data between any two RNCs, thereby enabling a remote terminal in a cell to communicate with a remote terminal in any other cell. In addition, a core network comprises gateway functions for interconnecting to external networks such as the Public Switched Telephone Network (PSTN), thereby allowing remote terminals to communicate with landline telephones and other communication terminals connected by a landline. Furthermore, the core network comprises much of the functionality required for managing a conventional cellular communication network including functionality for routing data, admission control, resource allocation, subscriber billing, remote terminal authentication etc.

The core network 109 is further coupled to a second RNC 111 which is coupled to a second base station 113. The second base station 113 supports a third remote terminal 115.

In the specific example of FIG. 1, the three remote terminals 101, 103, 115 are reconfigurable and are specifically Software Definable Radios (SDRs).

In the example, the radio communication system is coupled to an external authentication server 117 which is operated by a regulation body. In the specific example, the regulation body is a body that has responsibility for ensuring that devices of the radio communication system 100 meet the performance requirements of the systems such that acceptable performance of the individual devices and consequently of the system as whole.

In some embodiments, the authentication server 117 can be part of the radio communication system 100 and can be operated by the network operator. However, in the specific example, the authentication server is operated by an independent regulation body which ensures that a number of radio communication systems meet the appropriate performance requirements and thus that different communication systems can co-exist. Specifically, the authentication processor 117 can be operated by a 3GPP device certification authority or it can be operated by a state controlled regulation body.

In the specific example, the authentication server is external to the radio communication system 100 and is controlled and managed independently of the radio communication system 100 and without the involvement of the network operator for the radio communication system 100.

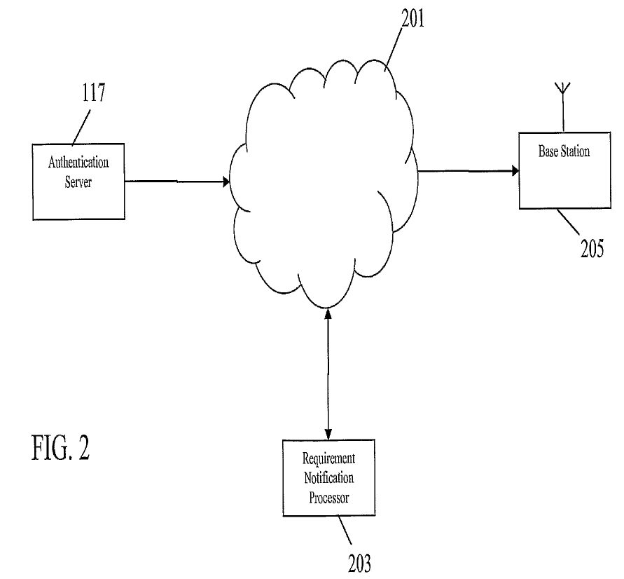

FIG. 2 illustrates a system for controlling reconfiguration in accordance with some embodiments of the invention. In particular, FIG. 2 illustrates the authentication server 117 and elements of the radio communication system 100 of FIG. 1.

In contrast to conventional systems wherein certification or authentication of a device is achieved by a manual and independent process of providing samples to a certification authority for testing in a test environment, the system of FIGS. 1 and 2 provides for a flexible and embedded certification or authentication process.

In particular, the regulation body operating the authentication server 117 can distribute performance requirements to individual remote terminals of the communication system. The remote terminals comprise functionality for autonomously and securely verifying that the remote terminals meet these requirements. A secure process for distributing such requirements and for ensuring that the requirements are met is provided. Furthermore, the process allows reconfiguration of the individual remote terminals without requiring independent certification of the reconfigured remote terminal by the regulation body. Specifically, the system allows both reconfiguration without certification and for the regulation body to control, manage and guarantee that the performance requirements are met.

FIG. 2 shows the authentication server 117 coupled to a network which specifically may be a heterogeneous network 201 comprising a number of subnetworks that may be operated by different network operators. For example, the heterogeneous network 201 may include the UMTS network of FIG. 1 in addition to other networks (such as WLANs) operated by other network operators.

The authentication server 117 defines performance requirements that must be met by the remote terminals of the communication system. For example, a spectral mask that must be met by the remote terminals or a frequency band to be used by the remote terminals can be determined by the authentication server 117 in response to a user input from an operator.

The performance requirements can be general performance requirements that must be met by all remote terminals. However the performance requirements can also be specific performance requirements that are related to specific remote terminals and even to specific configurations of specific remote terminals. For example, the performance requirements may relate specifically to remote terminals from a specific manufacturer and/or a specific model of a remote terminal and/or a specific firmware version. As another example, the performance requirements can be specified for giving geographical region and/or for a given time interval.

Thus, the performance requirements need not be specific standardised performance requirements for the radio communication system but can be specific performance requirements that ensure that the individual remote terminals operate as required. This flexibility can for example allow the regulation body to certify a given device model in terms of specific performance requirements that must be met while allowing the device model to be freely reconfigured without a new certification provided the performance requirements are met by the reconfigured remote terminal.

Furthermore, the approach allows the performance of the individual remote terminals to be adapted to the specific requirement within a given region or time interval.

As a specific example, during a rollout of a new radio communication system it may be essential that existing radio communication systems in the area are not impacted. Therefore, the regulation body may initially restrict the allowable out-of-band interference of the remote terminals to very low levels and may therefore provide performance requirements that reflect this. When reliable performance has been observed, the regulation body may allow higher interference to be caused to other systems and may therefore generate new performance requirements defining that a looser spectral mask can be applied in a specified region after a given time instant.

The authentication server 117 generates messages which comprise the performance requirements and forwards these messages to the heterogeneous network 201. Furthermore, the authentication server 117 includes a digital signature for the regulation body in the message. Specifically, the authentication server 117 can include a digital signature based on a private/public key encryption.

The messages are received by the heterogeneous network 201 which in the example is coupled to a requirement notification processor 203. It will be appreciated that the notification processor 203 may be a combined notification processor 203 for the different networks of the heterogeneous network 201 or that a separate notification processor unit may be operated by different network operators of the heterogeneous network 201. The requirement notification processor 203 is operable to generate performance requirement notifications in response to the performance requirement parameter messages from the authentication server 117.

The requirement notification processor 203 can in the specific embodiment simply generate the performance requirement notifications as suitable data messages which comprise the performance requirement data from the messages from the authentication server 117 and which are suitable for transmission to the remote terminals of the radio communication system.

The requirement notification processor 203 is furthermore arranged to check the digital signature in the messages from the authentication server 117. The requirement notification processor 203 specifically has the public key of the regulation body and can verify that the digital signature is indeed that of the regulation body. This allows the network operator of the radio communication system to verify that the messages are received from an appropriate authentication server.

Furthermore, in the example, the requirement notification processor 203 also includes the digital signature of the original regulation body in the performance requirement notifications. Furthermore, in the example the requirement notification processor 203 additionally includes a digital signature for the network operator of the radio communication system. Thus, the performance requirement notifications comprise means for allowing the remote terminals to verify both that the performance requirements originate from the appropriate external regulation body and that they are approved by the network operator of the UMTS radio communication system.

The requirement notification processor 203 transmits the performance requirement notifications to the remote terminals over the air interface of one or more of the different networks via one or more base stations 205 (or other suitable transmitting unit). For example, the performance requirement notifications can be forwarded to the first base station 105 by the first RNC 107 for transmission over a broadcast channel of the UMTS air interface. Alternatively or additionally, the performance requirement notifications can be transmitted using e.g. other broadcast services of other systems of the heterogeneous network 201, such as e.g. over a DVB-H (Digital Video Broadcast H) broadcast channel.

Thus, in many embodiments, the performance requirement notifications are broadcast to the remote terminals. This may reduce complexity and facilitate distribution of the performance requirement notifications to all relevant remote terminals. It will be appreciated that any suitable broadcast means can be used such as for example CBS (Cell Broadcast Service), DVB-H (Digital Video Broadcast H),

MBMS (Multimedia Broadcast Multicast Service) etc. The performance requirement notifications may for example be transmitted periodically and e.g. by use of carouselling techniques.

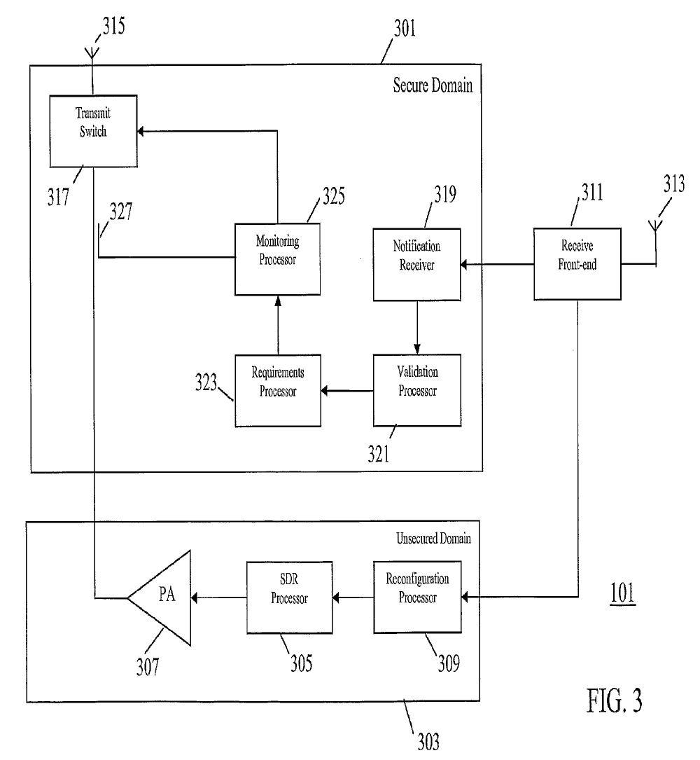

FIG. 3 illustrates an example of a reconfigurable radio equipment in accordance with some embodiments of the invention. The reconfigurable radio equipment may specifically be the first remote terminal 101 of FIG. 1 and will be described with reference to this.

The first remote terminal 101 is divided into a secure domain 301 and an unsecured domain 303. The operation of the functional elements of the secure domain 301 are explicitly and specifically certified by the regulation body operating the authentication server 117. Specifically, the secure domain 301 cannot be reconfigured without an explicit certification or authentication by the regulation body. In some embodiments, the secure domain 301 is not reconfigurable and cannot be modified following manufacture. Furthermore, the functionality of the secure domain 301 has been certified by the regulation body. This certification may for example have been through a conventional process where some sample devices have been certified by testing in a test environment by the regulation body.

Thus, the first remote terminal 101 is partitioned into two domains 301, 303 with one being subject to certification by the regulation body whereas the other one is not. In the example, the partitioning applies to both the hardware and software levels.

In the example of FIG. 3, the unsecured domain 303 is a reconfigurable radio transmit element. However, although the following description focuses on the applicability of the described principles to transmit functionality of the first remote terminal 101, it will be appreciated that the general principles can equally be applied to receive functionality.

The functionality of the unsecured domain 303 is reconfigurable and can be reconfigured without requiring an explicit certification by the regulation body. Thus, a reconfiguration of the unsecured domain 303 can be performed without any involvement of or even knowledge by the regulation body. Thus, the network operator of the UMTS radio communication system 100 and/or the manufacturer of the first remote terminal 101 can e.g. update the first remote terminal 101 without obtaining approval or otherwise involving the regulation body.

It will be appreciated that some functionality will inherently belong to the secure domain 301 or to the unsecured domain 303 whereas other functionality can belong to either the secure domain 301 or the unsecured domain 303.

In the specific example, the first remote terminal 101 is a software definable radio. Specifically, the first remote terminal 101 comprises an SDR processor 305 which comprises most of the functionality used for transmitting data to the first base station 105 over the UMTS air interface. The SDR processor 305 comprises digital signal processing software for filtering, modulating, up-converting and error coding data to be transmitted. It furthermore comprises control software for controlling the operation of other transmit functionality such as the operation and parameter setting for analogue transmit circuitry.

The SDR processor 305 is coupled to a power amplifier 307 which comprises analogue circuitry for up-converting the transmitted signal to the appropriate transmit frequency as well as functionality for amplifying the transmitted signal to the appropriate transmit power. The transmit frequency and transmit power is controlled by the SDR processor 305.

The SDR processor 305 and the power amplifier 307 are part of the unsecured domain 303 and can be reconfigured without the involvement of the regulation body. Specifically, the unsecured domain 303 of the first remote terminal 101 comprises a reconfiguration processor 309 which is capable of reconfiguring the SDR processor 305.

In the example, the reconfiguration processor 309 is coupled to the receiver front-end 311 which is coupled to a receive antenna 313. The receiver front-end 311 comprises functionality for down-converting and amplifying signals received from the first base station 105 by the receive antenna 313. The reconfiguration processor 309 comprises functionality for extracting reconfiguration data from the received signal. Thus the receiver front-end 311 and reconfiguration processor 309 may together implement the functionality of a UMTS receiver for receiving data messages over the air interface of the UMTS cellular communication system.

The reconfiguration processor 309 can receive reconfiguration data which is used to reconfigure the SDR processor 305. Specifically, the reconfiguration processor 309 can receive new software (or firmware) that replaces some or all of the software of the SDR processor 305. Thus, the UMTS transmit functionality can effectively and flexibly be updated and reconfigured. Furthermore, as the functionality which is affected is exclusively in the unsecured domain 303 this reconfiguration can be done without the involvement of the regulation body thereby substantially facilitating and reducing the burden of the reconfiguration process.

The secure domain 301 comprises functionality which monitors the performance of the transmit radio element formed by the unsecured domain 303 and ensures that this performance is always compliant with the performance requirements that are specified by the regulation body. Furthermore, the specific performance requirements to which the performance of the unsecured domain 303 is compared are determined in response to performance requirement notifications received over the air interface from the first base station 105.

The first remote terminal 101 comprises a transmit antenna 315 which is coupled to the power amplifier 307 through a transmit switch 317. (It will be appreciated that in many embodiments, the transmit and receive functionality can be coupled to the same antenna through a duplexer as is well-known to the person skilled in the art.) If the secure domain 301 detects that the operation of the unsecured domain is not compliant with the performance requirements for the first remote terminal 101, the transmit switch 317 de-couples the power amplifier 307 from the transmit antenna 315 such that no signal is transmitted from the first remote terminal 101. As the performance requirements are ultimately received from the authentication server 117 and determined by the regulation body, and as the functionality of the secure domain 301 cannot be changed without the certification of the regulation body, it is ensured that the operation of the unsecured domain 303 is compliant with the requirements set by the regulation body even though free reconfiguration of the unsecured domain 303 is allowed.

In more detail, the secure domain 301 comprises a notification receiver 319 which is coupled to the receiver front-end 311 and which is arranged to receive the performance requirement notifications transmitted by the first base station 105. Specifically, the notification receiver 319 comprises functionality for monitoring broadcast channels of the UMTS radio communication system and for detecting and decoding any performance requirement notifications broadcast by the serving base station.

The received performance requirement notifications are forwarded to a validation processor 321 coupled to the notification receiver 319.

The validation processor 321 is arranged to verify the validity of a received performance requirement notification. Specifically, the validation processor 321 is operable to check the digital signatures included in the performance requirement notifications.

In particular, the validation processor 321 has a certificate for the regulation body comprising the public key of the regulation body and by applying this to the digital signature of the performance requirement notification, it is investigated if the notification indeed originated from the appropriate regulation body.

In embodiments wherein a digital signature for the network operator is furthermore included in the notifications, the validation processor 321 also proceeds to apply the public key of the network operator to the digital signature contained in the performance requirement notification.

If the digital signatures correspond to the digital signatures of the appropriate regulation body and network operator, the validation processor 321 considers that the performance requirement data is valid.

In the specific embodiment, the performance requirement notifications may furthermore include data which defines the applicability of the performance requirements. Specifically, this data can specify a manufacturer, model number, firmware code version, geographical region and/or time interval to which the requirements apply. In this embodiment, the validation processor 321 proceeds to compare this data to the specific data for the first remote terminal 101.

If the data matches the characteristics for the first remote terminal 101, and if the digital signatures are found to be valid, the validation processor 321 forwards the performance requirement data to a requirements processor 323 coupled to the validation processor 321. The requirements processor 323 proceeds to determine specific performance parameters that must be met by the unsecured domain 303. The requirements processor 323 can e.g. specify a maximum transmit power and/or a spectral mask with which the output transmit signal must comply.

The requirements processor 323 can thus dynamically update the performance requirements for the remote terminal 101 to correspond to performance requirements which are specified by the regulation body. Furthermore, this dynamic updating is secure and can be used to ensure that the reconfigurable radio element (i.e. the unsecured domain 303) meets the current performance requirements from the regulation body.

The requirements processor 323 is coupled to a monitoring processor 325 which is fed the performance parameters. The monitoring processor 325 is furthermore coupled to a sensor 327 which senses the signal fed to the transmit antenna 315 (or to the transmit switch 317). Thus, the monitoring processor 325 is fed a version of the transmitted signal which it compares to the performance parameters.

Specifically, the monitoring processor 325 can comprise a signal level detector which detects if the transmit power exceeds a transmit power level given by the performance parameters, or can e.g. comprise a spectrum analyser allowing the transmit output signal to be compared to the required spectral mask for the signal.

The monitoring processor 325 is coupled to the transmit switch 317 and if the monitoring processor 325 detects that the performance of the unsecured domain 303 is not compliant with the performance parameters, for example if the transmit power level exceeds the threshold or the spectrum mask is exceeded, it activates the transmit switch 317 such that the power amplifier 307 is de-coupled from the transmit antenna 315.

Thus, if the secure domain 301 detects that the performance requirements specified by the regulation body are not met by the unsecured domain 303, it proceeds to enter the first remote terminal 101 into a limited mode of operation wherein it is ensured that the performance requirements are not violated. In the specific example, the limited mode of operation corresponds to a full termination of the transmit functionality such that the interference to other units and systems is removed. It will be appreciated that in other embodiments less extreme limitations may be implemented. For example in some embodiments, the output transmit power may be gradually reduced until the operation is compliant with the specified performance requirements.

In some embodiments, the secure domain functionality can be implemented and certified during design and manufacture with no possibility of later modification or reconfiguration. This may allow a very secure system wherein only the performance requirement data but not the functionality of the secure domain 301 can be modified.

In other embodiments, the secure domain 301 may also be reconfigurable allowing the functionality to be modified. For example, the monitoring processor 325 may initially be provided with firmware for monitoring output power levels but may later be reconfigured to include a spectrum analyser for comparing the output signal to a spectral mask. However, this reconfiguring of the secure domain 301 is subject to certification and authentication by the regulation body thereby ensuring that the operation of the first remote terminal 101 is guaranteed to be compatible with the requirements specified by the regulation body.

Specifically, the notification receiver 319 can also be arranged to receive reconfiguration parameters, such as replacement firmware, for the secure domain 301. The validation processor 321 can validate that the new firmware is certified by the regulation body. For example, it may be arranged that any new firmware is only applied if it is received with a digital signature from the regulation body. If the new firmware is valid, the validation processor 321 can proceed to replace the appropriate firmware. However, if the certification or authentication of the firmware by the regulation body cannot be confirmed, the firmware is ignored and no reconfiguration of the secure domain 301 takes place.

Thus, the described system may allow reconfiguration in a radio communication system wherein new configurations, such as new SDR firmware, can be freely introduced to an unsecured domain while ensuring that the remote terminal is compliant with the performance requirement specified by the regulation body. Thus, a much more flexible and facilitated reconfiguration and certification framework can be implemented providing both secure and reliable performance while allowing flexibility and freedom in reconfiguring individual devices without involving certification or authentication by a regulation body. Specifically, the system introduces the possibility for the regulation body to selectively control a large number of reconfigurable radio equipment by sending them performance requirement notifications. The system also introduces a divided architecture for the reconfigurable radio equipment allowing any violation of the regulation policies defined by a (n external) regulation body. In this context, it is sufficient to only apply a certification process to the secure part of the reconfigurable radio equipment and to ignore the reconfigurable radio element of the unsecured domain during the certification process.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A reconfigurable radio equipment for a radio communication system, the reconfigurable radio equipment comprising:
a reconfigurable radio element;
receiving means for receiving performance requirement notifications over an air interface of the radio communication system, the performance requirement notifications defining performance requirements for the operation of the reconfigurable radio equipment;
a secure certification processor comprising:
monitoring means for monitoring compliance of the reconfigurable radio element with a first set of performance requirements;
validation means for verifying the validity of a received performance requirement notification;
update means for updating the first set of performance requirements in response to the received performance requirement notification only if the received performance requirement notification is valid; and
wherein the monitoring means is arranged to enter the reconfigurable radio equipment into a limited mode of operation if the reconfigurable radio element is not compliant with the first set of performance requirements.

2. The reconfigurable radio equipment of claim 1 wherein the first set of performance requirements comprises a transmit power requirement.

3. The reconfigurable radio equipment of claim 1 wherein the first set of performance requirements comprises a transmit power spectral mask.

4. The reconfigurable radio equipment of claim 1 wherein the limited mode of operation comprises a reduction of output transmit power.

5. The reconfigurable radio equipment of claim 1 wherein the received performance requirement notification comprises a digital signature of a source of the performance requirements; and wherein the validation means is arranged to validate the received performance requirement notification by validating the digital signature.

6. The reconfigurable radio equipment of claim 1 wherein the receiving means is arranged to receive the performance requirement notifications in broadcast messages.

7. The reconfigurable radio equipment of claim 1 wherein the secure certification processor is not reconfigurable.

8. The reconfigurable radio equipment of claim 1 wherein the secure certification processor further comprises
means for receiving reconfiguration parameters for the secure certification processor;
means for verifying the validity of received reconfiguration parameters; and
means for reconfiguring the secure certification processor only if the received reconfiguration parameters are valid.

9. The reconfigurable radio equipment of claim 1 further comprising means for receiving reconfiguration parameters for the reconfigurable radio element over the air interface and means for reconfiguring the radio element in response to the reconfiguration parameters.

10. The reconfigurable radio equipment of claim 1 wherein the validation means is arranged to verify the validity of the received performance requirement notification by verifying that the received performance requirement notification is certified by a certification authority; and wherein the reconfigurable radio element is arranged to be reconfigured without verifying that the reconfiguration is certified by the certification authority.

11. The reconfigurable radio equipment of claim 1 wherein the air interface is an air interface of a cellular communication system.

12. The reconfigurable radio equipment of claim 1 wherein the reconfigurable radio equipment is a remote terminal of a cellular communication system.

13. A radio communication system comprising:
means for receiving performance requirement reconfiguration parameter messages from a certification server;
means for generating performance requirement notifications in response to the performance requirement reconfiguration parameter messages, the performance requirement notifications defining performance requirements for the operation of at least one reconfigurable radio equipment; and
means for transmitting the performance requirement notifications to remote units over an air interface of the radio communication system.

14. The radio communication system of claim 13 wherein at least one of the remote units is a reconfigurable radio equipment comprising:
a reconfigurable radio element;
receiving means for receiving the performance requirement notifications;
a secure certification processor comprising:
monitoring means for monitoring compliance of the reconfigurable radio element with a first set of performance requirements;
validation means for verifying the validity of a received performance requirement notification;
update means for updating the first set of performance requirements in response to the received performance requirement notification only if the received performance requirement notification is valid; and
wherein the monitoring means is arranged to enter the reconfigurable radio equipment into a limited mode of operation if the reconfigurable radio element is not compliant with the first set of performance requirements.

15. The radio communication system of claim 13 wherein the performance requirement reconfiguration parameter messages comprise a digital signature of a regulating authority and wherein the means for generating performance requirement notifications comprise means for validating the digital signature.

16. The radio communication system of claim 13 wherein the performance requirement reconfiguration parameter messages comprise a digital signature of a regulating authority, the means for generating performance requirement notifications comprise means for including the digital signature in the performance requirement notifications and the remote units comprise means for validating the digital signature.

17. The radio communication system of claims 13 wherein the means for generating performance requirement notifications comprise means for including a network digital signature of an operator of the radio communication system in the performance requirement notifications and the remote units comprise means for validating the network digital signature.

18. The radio communication system of claims 13 wherein the means for generating performance requirement notifications comprise means for including an identification of an applicability of the performance requirements.

19. A method of reconfiguring a reconfigurable radio equipment having a reconfigurable radio element, the method comprising:
receiving performance requirement notifications over an air interface of the radio communication system, the performance requirement notifications defining performance requirements for the operation of the reconfigurable radio equipment; and
in a secure certification processor performing the steps of:
monitoring compliance of the reconfigurable radio element with a first set of performance requirements;
verifying the validity of a received performance requirement notification;
updating the first set of performance requirements in response to the received performance requirement notification only if the received performance requirement notification is valid; and
entering the reconfigurable radio equipment into a limited mode of operation if the reconfigurable radio element is not compliant with the first set of performance requirements.

20. A method of reconfiguration in a radio communication system, the method comprising:
receiving performance requirement reconfiguration parameter messages from a network regulation server;
generating performance requirement notifications in response to performance requirement reconfiguration parameter messages, the performance requirement notifications defining performance requirements for the operation of at least one reconfigurable radio equipment; and
transmitting the performance requirement notifications to remote units over an air interface of the radio communication system.
